(19) United States
(12) Patent Application Publication
(10) Pub. No.: US 2010/0007600 A1
(43) Pub. Date: Jan. 14, 2010

(54) METHOD FOR LIGHT EMITTING DIODE CONTROL AND CORRESPONDING LIGHT SENSOR ARRAY, BACKLIGHT AND LIQUID CRYSTAL DISPLAY

(75) Inventors: Peter Hubertus Franciscus Deurenberg, Eindhoven (NL); Henricus Marie Peeters, Eindhoven (NL); Marco Van As, Eindhoven (NL); Christoph Gerard August Hoelen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/518,292

(22) PCT Filed: Dec. 10, 2007
(86) PCT No.: PCT/IB2007/054986

§ 371 Date: Jun. 9, 2009

(30) Foreign Application Priority Data
Dec. 13, 2006 (EP) 06125998.2

(51) Int. Cl. G09G 3/36; H05B 37/02

(52) U.S. Cl. 345/102; 315/151

(57) ABSTRACT

It is presented a method for controlling a light level of light emitting diodes, LEDs, comprised in a light sensor segment comprising a light sensor and a plurality of LEDs, the method comprising the steps of: turning on all LEDs in an LED segment, comprising at least one of the plurality of LEDs, detecting a light level associated with the LED segment, by detecting a light level using the light sensor, repeating the steps of turning on all LEDs in an LED segment and detecting a light level, until all of the plurality of LEDs are turned on, and for each LED of the plurality of LEDs, controlling a light intensity of the each LED of the plurality of LEDs, the intensity control depending on the detected light level associated with an LED segment containing the each LED of the plurality of LEDs. A corresponding light sensor array, backlight for a display system and liquid crystal display are also presented.

### FIELD OF THE INVENTION

The present invention relates to light emitting diodes and more particularly to controlling a light level of light emitting diodes.

### BACKGROUND OF THE INVENTION

Light Emitting Diodes (LEDs) can be used for many purposes. One such purpose is to provide backlighting for Liquid Crystal Display (LCD) televisions. With other television technologies, light is often generated as part of the image rendering. For example, in Cathode Ray Tube (CRT) televisions, electrons are shot on a fluorescent screen to render a video image to the user, whereby light is generated in the same process as the video image is rendered. Rendering of images using LCDs in LCD televisions however, does not produce light inherently and requires either reflected light from the room or, more commonly, a light source for the user to be able to view the video image with sufficient light intensity.

Traditionally, fluorescent tubes are used as backlight in LCD displays, but lately LEDs provide an attractive alternative. There are some clear advantages to using LEDs within a backlight (e.g. wider color gamut, i.e. color range), however, there are a few technical challenges which need to be solved. An example of such a challenge is color consistency over time and spatial color uniformity of the backlight. This is a challenge because the output of LEDs changes strongly when their temperature rises, but also during ageing. A temperature difference between two LED segments of 20° C. is already more than enough to result in a visible color difference if no color feedback method is applied. Controlling color over time requires a significant amount of components, resulting in a significant cost.

Consequently, there is a need to provide a method and a light sensor segment, that more efficiently provides control of LEDs.

### SUMMARY OF THE INVENTION

In view of the above, an objective of the invention is to solve or at least reduce the problems discussed above.

Generally, the above objectives are achieved by the attached independent patent claims. A first aspect of the invention is a method for controlling a light level of light emitting diodes, LEDs, comprised in a light sensor segment comprising a light sensor and a plurality of LEDs, the method comprising the steps of: turning on all LEDs in an LED segment, comprising at least one of the plurality of LEDs, detecting a light level associated with the LED segment, by detecting a light level using the light sensor, repeating the steps of turning on all LEDs in an LED segment and detecting a light level, until all of the plurality of LEDs are turned on, and for each LED of the plurality of LEDs, controlling a light intensity of the each LED of the plurality of LEDs, the intensity control depending on the detected light level associated with an LED segment containing the each LED of the plurality of LEDs. With such a method, a feedback loop is achieved, whereby color and intensity are controlled efficiently.

The method may further comprise the step of turning off the plurality of LEDs.

The steps of turning on all LEDs in an LED segment, detecting a light level, repeating, controlling a light intensity and turning off the plurality of LEDs may be repeated periodically, for a plurality of light sensor segments. This allows updating of the LEDs, for example matching changes in a video signal.

The step of turning on all LEDs in an LED segment may involve turning on all LEDs in the LED segment, the LED segment comprising at least a red, a green and a blue LED, and the step of detecting a light level associated with the LED segment may involve detecting a light level associated with the LED segment, by detecting at least three separate light levels using the light sensor capable of detecting at least red, green and blue light independently, the at least three light levels being associated with the at least red, green and blue LEDs, respectively. This provides an efficient use in the time domain, as only one light sensor is used, allowing the light level for the different colors to be measured in the same time period.

The step of turning on all LEDs in an LED segment may involve turning on one LED of the plurality of LEDs, the one LED constituting the LED segment, the one LED having one color. This allows all colors to be independently measured, whereby there is no need for a light sensor capable of independently detecting light levels of different colors.

The step of controlling a light intensity of the each LED of the plurality of LEDs may involve for each LED of the plurality of LEDs, controlling a light intensity of the each LED of the plurality of LEDs, depending on the light level associated with an LED segment containing the LED each LED of the plurality of LEDs and depending on a state of all of the plurality of LEDs at a time the light level associated with the LED segment containing the LED each LED of the plurality of LEDs was detected. By considering the state of other LEDs, a more accurate measurement is yielded.

The plurality of LEDs may be arranged in a matrix pattern, and the method may further comprise a step, before the detecting a light level, of: turning on all LEDs in LED segments of the light sensor segment situated in another matrix row with respect to a matrix row of the LED segment. By turning on the LEDs in a LED segment, the state is known for the other LEDs as being turned on.

The plurality of LEDs may be arranged in a matrix pattern, and the method may further comprise a step, before the detecting a light level, of: turning off all LEDs in LED segments of the light sensor segment situated in another matrix row with respect to a matrix row of the LED segment. By turning off the LEDs in a LED segment, the state is known for the other LEDs as being turned off.

The method may be adapted for controlling a light level of LEDs of a plurality of light sensor segments, the light sensor segments being arranged in a matrix pattern.

A second aspect of the invention is a light sensor segment comprising: a light sensor for detecting a light level, a plurality of light emitting diodes, LEDs, and a controller, wherein the controller comprises means for turning on all LEDs in an LED segment, comprising at least one of the plurality of LEDs, at a time being distinct from times for turning on any other of the plurality of LEDs, the associated controller further comprises means for detecting a light level associated with the LED segment for each of the plurality of LEDs, after the all LEDs in the LED segment are turned on and before any other of the plurality of LEDs are turned on.

The LED segment may comprise at least a red, a green and a blue LED. Note that other colors are also possible, such as amber.

The light sensor may comprise means for detecting a light level for each LED in the LED segment using a light sensor capable of detecting at least red, green and blue light independently, the red, green and blue light being associated with the red green and blue LED, respectively.

The associated controller may comprise means for turning on one of the plurality of LEDs at a time being distinct from turning on any other of the plurality of LEDs, where the one of the plurality of LEDs has one distinct color.

The light sensor segment may further comprise a reflecting surface, and the light sensor may be arranged on one side of the reflecting surface and the LEDs may be configured to project light to a second side of the reflecting surface. In other words, the sensor is behind the reflecting surface from where the light is projected. The sensor still gets enough light, so holes for the sensors in the reflective surface are avoided.

The light sensor segment may further comprise a reflecting surface, and the light sensor may be arranged by an opening of the reflecting surface on one side of the reflecting surface and the LEDs may be configured to project light to a second side of the reflecting surface. In other words, the sensor is behind holes the reflecting surface from where the light is projected. The amount of light provided to the sensor is thus increased.

The opening may be a circular opening, and the light sensor may be arranged such that a center of the light sensor aligns with a center of the opening.

The light sensor segment may further comprise a lens arranged by the light sensor.

A reflective tube may be arranged between the opening and the sensor.

A third aspect of the invention is a backlight for a display system comprising at least one light sensor segments according to the second aspect.

The backlight for a display system may comprise one controller being an associated controller for all of the at least one light sensor segments.

The backlight for a display system may further comprise at least one pin hole array arranged such that light sensors of the light sensor segments are located on a first side of the at least one pin hole array and LEDs of the light sensor segments may be configured to project light on a second side of the at least one pin hole array, the at least one pin hole array restricting a sensor direction for detecting light for each of the light sensors. This provides better control on what light directions are allowed to affect the light detected by the light sensor.

The backlight for a display system may comprise a lens array arranged such that light sensors of the light sensor segments are located on a first side of the lens array and LEDs of the light sensor segments are configured to project light on a second side of the lens array, the backlight for a display system further comprising a pin hole array arranged between the lens array and the light sensors.

A fourth aspect of the invention is a liquid crystal display comprising at least one liquid crystal display according to the third aspect.

Other objectives, features and advantages of the present invention will appear from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, device, component, means, step, etc” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Embodiments of the present invention will now be described in more detail, reference being made to the enclosed drawings, in which:

FIG. 1 is schematic diagram showing relevant components of an LCD (liquid crystal display) television where the present invention is embodied.

FIGS. 2A-C are schematic diagrams showing various possible LED and sensor arrangements in the LED backlight of FIG. 1.

FIGS. 3A and 3B show how a light sensor in an embodiment of the present inventions distinguishes between light from several LED segments using time multiplexing.

FIG. 4 is a diagram showing a way of controlling LED states in an embodiment of the present invention.

FIGS. 5A-D show various ways of arranging light sensors in embodiments of the present invention in an LCD television backlight.

FIGS. 6A-D show embodiments of the present invention utilizing pin hole arrays.

FIG. 7 shows a side view of a single sensor arranged according to an embodiment of the present invention.

### DETAILED DESCRIPTION OF EMBODIMENTS

The present invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

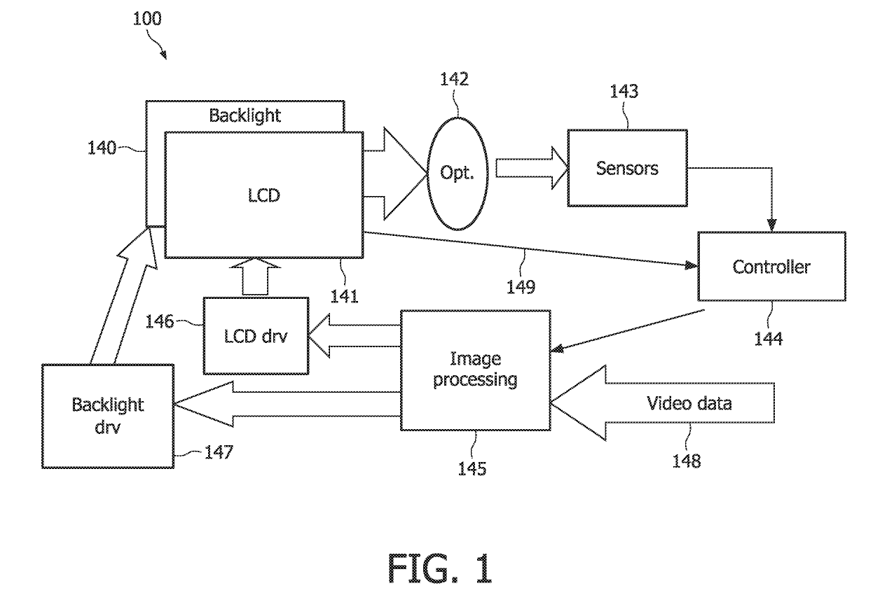

FIG. 1 is schematic diagram showing relevant components of an LCD (liquid crystal display) television 100 where the present invention is embodied.

Video data 148 is fed from a suitable source, e.g. television tuner (analogue or digital), DVD player, video game console, VCR, computer, etc. The video data 148 is received in an image processing module 145, which divides the video signal in a signal to an LCD driver module 146 and a signal to a backlight driver module 147. The image processing module 145 is also responsible for ensuring that these signals are in a suitable format for the driver modules 146, 147 to interpret. The LCD driver module 146 provides a signal to an LCD panel 141 based on the signal provided by the image processing module 145. Similarly, the backlight driver module 147 drives a backlight 140 based on the signal provided from the image processing module 145. The backlight 140 thus provides light which is based on the video signal. In this example, the backlight 140 comprises a matrix of LEDs (light emitting diodes). The LCD panel 141 filters the light and provides a detailed image which is based on the original video data 148. Together, the video data dependent backlight 140 and the LCD panel 141 provide a picture with a larger color gamut than would be the case if the backlight was a traditional backlight based on fluorescent tubes. A user of the screen can thereby see a vivid image based on the video data 148.

Now a feedback mechanism will be described, allowing adjustment to the image due to inconsistencies of LEDs in the backlight 140. These inconsistencies may be due to the fact that an output of LEDs changes strongly when their temperature rises, but also during ageing. With a feedback loop, the inconsistencies can be compensated in the image processing module 145, which can then provide an adjusted image signal to the backlight 140, whereby the intensity of each LED in the matrix of LEDs can be adjusted.

Optionally, first in the feedback loop is an optical element 142, improving the light to be detected by a matrix of light sensors 143. The details about this matrix is described in more detail below. Generally, it detects a light level from the LED panel 140 in a two-dimensional matrix. A signal is generated and sent to a controller 144. The controller may be implemented by any commercially available CPU (Central Processing Unit), DSP (Digital Signal Processor), a combination of circuits or any other electronic programmable logic device. Additionally, as temperature affects LED performance, a temperature sensor (not shown) generates temperature data 149, which may be zero-dimensional, one-dimensional or two-dimensional, and provides this data 149 to the controller 144. Based on the data from the light sensor matrix 143 and the temperature sensor, the controller calculates an adjustment signal and provides this to the image processor 145. Subsequently, the image processor combines the adjustment signal and the video data in order to provide an adjusted image to the user.

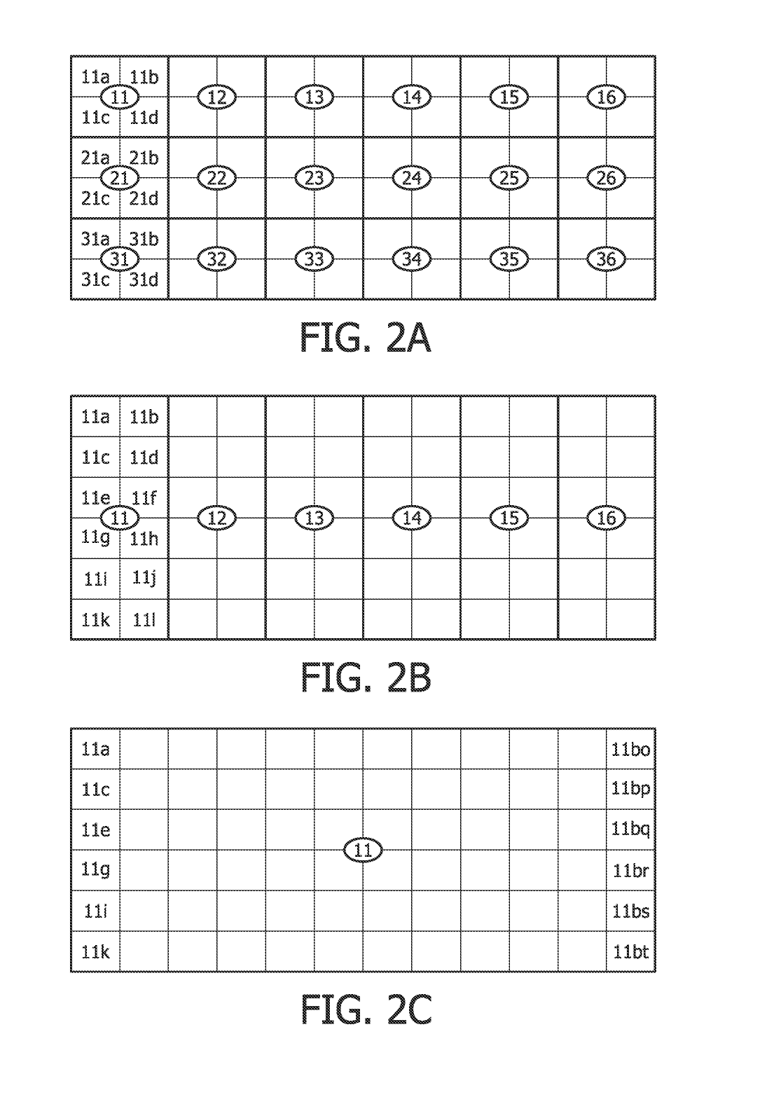

FIGS. 2A-C are schematic diagrams showing various possible LED and sensor arrangements in the LED backlight 140 of FIG. 1.

In FIG. 2A, a light sensor 11 is arranged to detect light related to four LED segments 11a-d. The light sensor 11 combined with the four LED segments 11a-d is denoted an light sensor segment. Correspondingly, a light sensor 21 is arranged to detect light related to four LED segments 21a-d and a light sensor 31 is arranged to detect light related to four LED segments 31a-d. Light sensors 12-16, 22-26 and 32-36 are also arranged to detect light from four LED segments for each light sensor. Consequently, there are as many light sensor segments as there are light sensors, i.e. 18 light sensor segments in FIG. 2A.

An LED segment, e.g. 11a, can have three LEDs in red, green and blue to allow color mixing, or the LED segment can have only one LED with one color, where colored light from several LED segments are thus mixed.

In FIG. 2B, it is shown a sensor arrangement comprising 6 light sensor segments, with light sensors 11-16, each segment having 12 associated LED segments. For example, light sensor 11 has 12 associated LED segments 11a-11l.

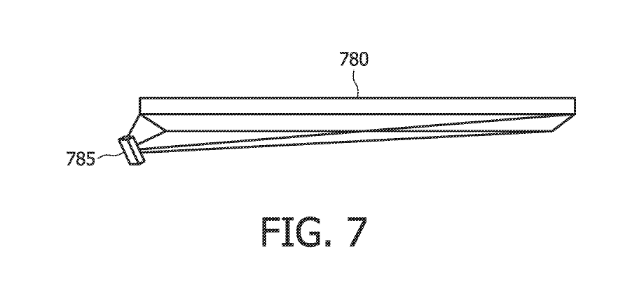

In FIG. 2C, it is shown a sensor arrangement comprising only 1 light sensor segment, with light sensor 11, where the segment has 72 associated LED segments. Light sensor 11 consequently has 72 associated LED segments 11a-11bt (only part of these are labeled). Note that this is a schematic illustration and a more detailed positioning of the light sensor 11 in one embodiment is shown in FIG. 7, described below.

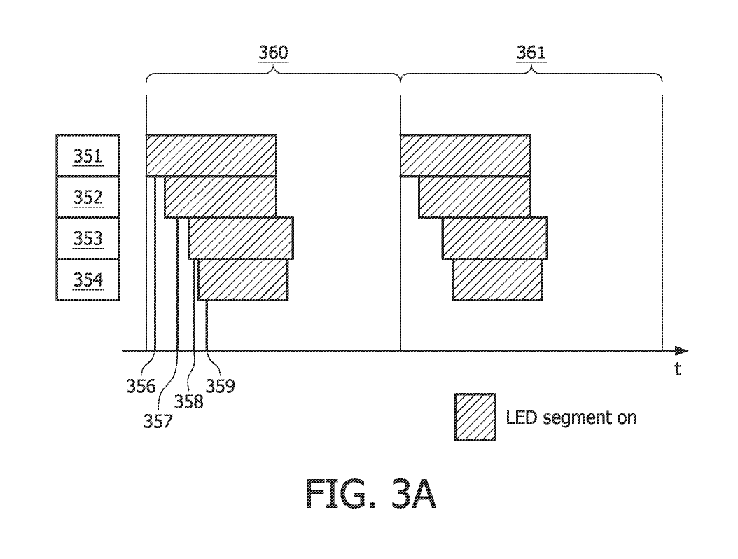

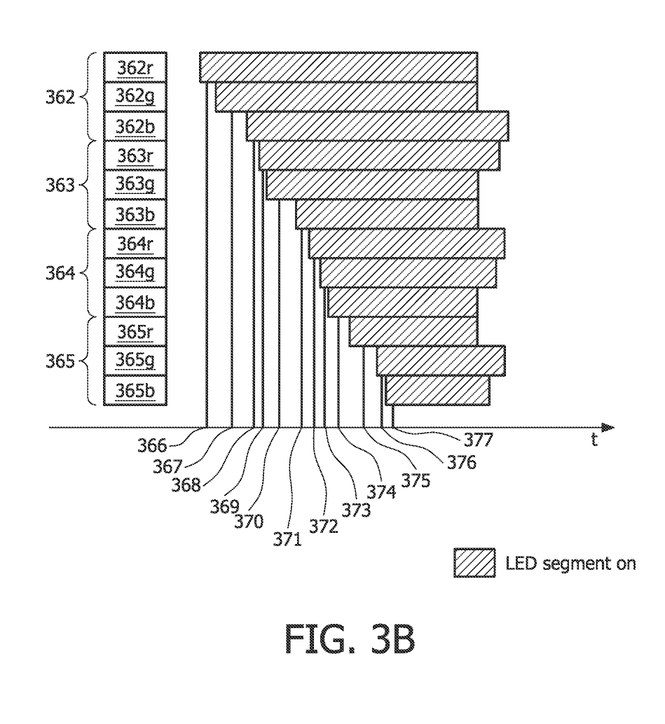

FIGS. 3A and 3B show how a light sensor in an embodiment of the present inventions distinguishes between light from several LED segments using time multiplexing.

According to the present invention, by applying time multiplexing, it is still possible to discern the output of individual LED segments by a single light sensor. Time multiplexing means that adjacent LED segments are not turned on at the same moment and sampled, but turned on slightly after each other and sampled multiple times. In FIG. 3A, in a first period 360 (corresponding to one frame in a video sequence), four exemplary LED segments 351-354 are turned on at different times. The four LED segments 351-354, together with a light sensor (not shown) make up a light sensor segment. At the beginning of the first period 360, all LED segments 351-354 are turned off. Light segment 351 is turned on first and the light sensor detects light at a time 356. Subsequently, light segment 352 is turned on and the light sensor detects light at a time 357. This is followed by light segment 353 being turned on and the light sensor detecting light at a time 358. Finally, light segment 354 is turned on and the light sensor detects light at a time 359. The process is repeated for subsequent periods, such as period 361. It is to be noted that each LED segment can be turned on during different amounts of time. This is due to pulse width modulation (PWM). As is known in the art, PWM adjusts the amount of time in each period that a certain LED is turned on, thereby adjusting perceived brightness of that LED.

In this embodiment, the sensor is an RGB sensor, capable of detecting red, green and blue light independently. Consequently, if each LED segment comprises red, green and blue LEDs, all LEDs of each segment can be switched on at the same time, and the light sensor can still detect light from each individual LED.

Consequently, from the measurements at times 356-359, it can be calculated how much light each color of each LED segment 351-354 produces, which is fed to a feedback loop as described above.

FIG. 3B shows a situation where 12 LEDs are turned on sequentially. There are four sensor segments 362-365. Each segment has a red, a green and a blue LED: 362r, 362g, and 362b for sensor segment 362; 363r, 363g, and 363b for sensor segment 363; 364r, 364g, and 364b for sensor segment 364, and 365r, 365g; and 365b for sensor segment 365. All the LEDs are turned on in sequence, whereby the associated light sensor can sample at times 366-377 to be able to deduce a light associated with each LED. As each single LED is switched on at its own time, a simple light sensor (not a RGB sensor) can be used, reducing component cost.

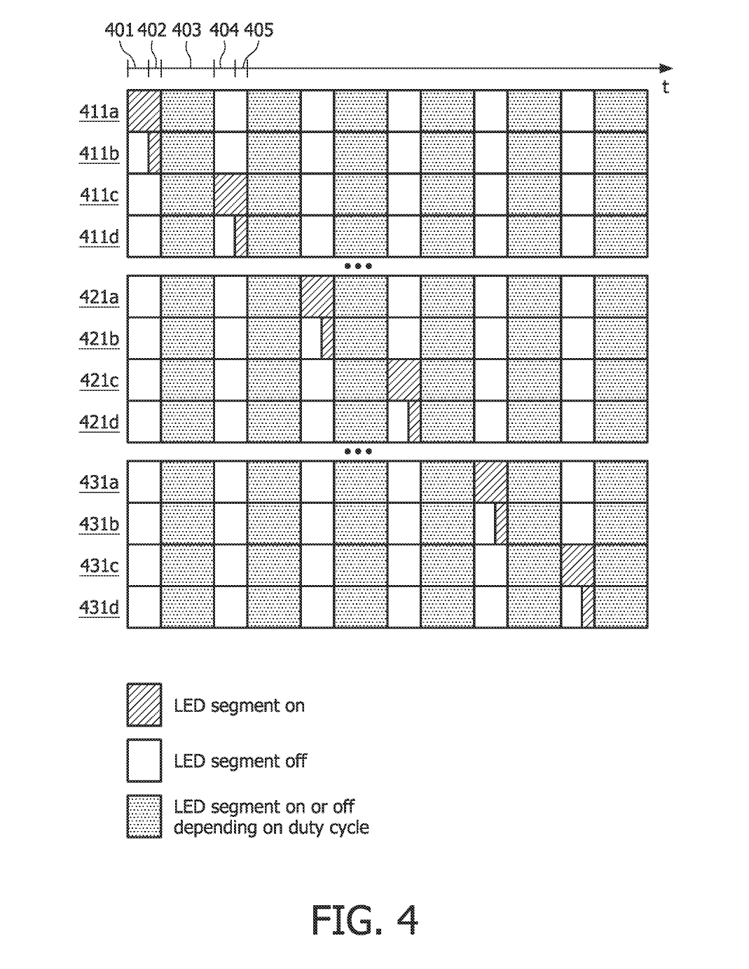

FIG. 4 is a diagram showing a way of controlling LED states in an embodiment of the present invention.

In order to retrieve sensible, defined measurements, it helps to make sure the light output of the backlight is defined during each measurement. This is not trivial, because PWM, as explained above, is used to set the amount of light (of each color in each LED segment) and the measurement moments are distributed over a frame time due to the scanning motion of the video information.

The diagram has a number of rows, where each row represents one LED segment. LED segments 411a-d correspond to light sensor segment 11 of FIG. 2A, LED segments 421a-d correspond to light sensor segment 21 of FIG. 2A, and LED segments 431a-d correspond to light sensor segment 31 of FIG. 2A. Time is represented on the horizontal axis. As can be seen in FIG. 2A, LED segments 11a and 11b are on one row in the matrix, along with LED segments for light sensor segments 12 to 16. LED segments 11c and 11d are on another row in the matrix.

An approach to deal with the uncertainty of other LED segment states, is to set a fixed state of the LED segments as is shown in FIG. 4. This diagram shows LED segment states for time resolved measurements in a backlight with 18 sensors (as indicated in FIG. 2). It is clearly shown, that if measurements are taken in time periods 401 and 402, only a single row is active, and the other rows are turned off. In addition, the moment this happens changes during the frame time due to the scanning motion of the video information. Note that one may also choose for a different solution as indicated before, as long as the stable situation of the light falling onto the sensor is maintained. For example, other segments could equally well be turned on during measurement times.

An added advantage of this way of working is that during measurement, there is no switching of (substantial) currents in the backlight. This reduces the potential interference (electrical crosstalk) for the sensor. It may be necessary to avoid switching of the entire backlight at once just after sample time 402 (large dI/dt). This is possible by e.g. switching the rows subsequently at very short intervals.

Due to the state control of switching LED segments on or off without considering PWM, the maximum and minimum duty cycles in a backlight using the above approach are affected. However, this change is quite small. Assuming a Taos TCS230 digital color sensor is placed in a backlight unit with 86% reflective optical stack and an optical thickness of 50 mm, the measurement time required for 401 is about 46 μs and for 402 about 23 μs. A very safe estimate before a constant current is realized after switching on is 25 μs. Therefore, 401 takes about 75 μs and 402 about 50 μs.

The minimum and maximum duty cycle for odd and even column numbers can be found by using the following formulae, where column numbers start with number one on the leftmost column and increase to the right:

$$min DC evencolnbr = \frac{( {S}_{1} + {S}_{2} )}{Ft}$$

$$max DC evencolnbr = \frac{Ft - 5 \cdot ( {S}_{1} + {S}_{2} )}{Ft}$$

$$min DC oddcolnbr = \frac{{S}_{2}}{Ft}$$

$$max DC oddcolnbr = \frac{Ft - 5 \cdot ( {S}_{1} + {S}_{2} ) - {S}_{1}}{Ft}$$

Substituting with S₁ with 75 μs, S2 with 50 μs and a frame time Ft= 1/60 s, we find:

min DC evencolnbr=0.75%
max DC evencolnbr=96.25%
min DC oddcolnbr=0.30%
max DC oddcolnbr=95.80%

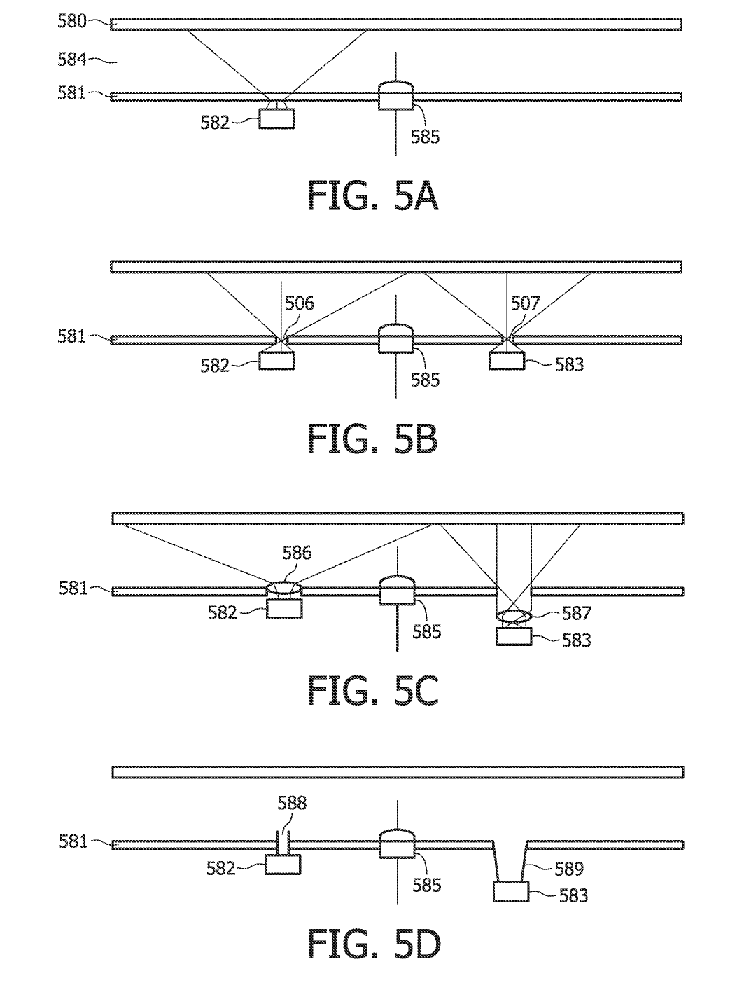

FIGS. 5A-D show various ways of arranging light sensors in embodiments of the present invention in an LCD television backlight.

Backlights for LCD televisions generally consist of a light-mixing chamber 584, with a highly reflecting white coating 581, in other words a reflecting surface 581. Each LED 585 and/or sensor 582 that is inside the light-mixing chamber causes a reduction of the efficiency due to the absorption of light by the LED 585 and/or sensor 582. Because of the multiple scattering events (and the high degree of light reflection by optical foils 580 such as scattering foils, BEF and/or DBEF foils that are mounted between the light mixing chamber and the LCD panel), the absorption sites have a significant influence on the overall system efficiency. In a (locally) dimmable backlight typically multiple sensors have to be used to control the color and flux of the LEDs, so more absorption can be expected.

In FIG. 5A, to reduce the effects of the sensor absorption it is shown how the sensor 582 is placed below the light reflecting coating 581. Another advantage of the this configuration is that the sensors 582 do not see any direct light emitted by the LEDs 585, which is highly unwanted because it is the flux and color point distribution of the front scattering foil 580 that should be controlled, and, as a consequence, should be monitored. The light reflecting coating 581 is for example a MC-PET plate or foil.

Typically MC PET foils have a light transmission of 2%, and almost no absorption. Due to the high light level in the light mixing chamber, enough light leaks through the reflecting foil to provide the sensor 582 with light. In this way the sensors do not reduce the backlight efficiency at all.

FIG. 5B shows an embodiment where the sensors 582, 583 are placed behind openings 506, 507 in the light reflecting coating 581. An important issue is that each sensor 582, 583 is designed to control a predefined number of LEDs 585 adjacent to the sensor. By puncturing the light reflecting foil 581 on top of the sensor 582, 583 with a controlled diameter and position it is possible to select a region of the diffuser area the sensor gets most of its information from. A circular opening 507 that is concentric with the sensor 583 selects a circular area on the diffuser sheet (or “area of interest”) that contributes to the sensor reading (as long as the sensor is large enough, otherwise the shape of the area of interest is defined also by the sensor shape). Also non-concentric combinations of opening 506 and sensor 582 can define ex-centric areas of interest relative to the sensor position.

FIG. 5C shows an embodiment where the sensors 582, 583 are placed behind lenses 586, 587 in the light reflecting coating 581. In this embodiment, a lens 586, 587 is applied between the opening and the sensor 582, 583, e.g. to project the opening on the sensor 582, 583 or to define the location or shape of the “area of interest”.

FIG. 5D shows an embodiment where a reflective tube 588, 589 is arranged between the sensor 582, 583 and the light reflecting coating 581. In any embodiment with a opening and a sensor, it can be advantageous to apply the reflecting tube 588, 589 around the sensor 582, 583 to shield it from unwanted stray light that may be present below the diffuse reflector. The reflector tube 588, 589 may extend up to the reflector foil 581 or may even extend above this foil 581 to further reduce the chance of capturing direct light from the LEDs.

Additionally, in the mentioned embodiments a light guide (e.g. an optical fiber) may be placed above the sensor(s) to capture light and transport it to the sensor. Again, this light guide may extend up to or through the reflector foil 581, and even up to the front scattering foil 580 (or optical stack). By approaching the front scattering foil 580, more and more localized sensing of the flux and/or color point is possible.

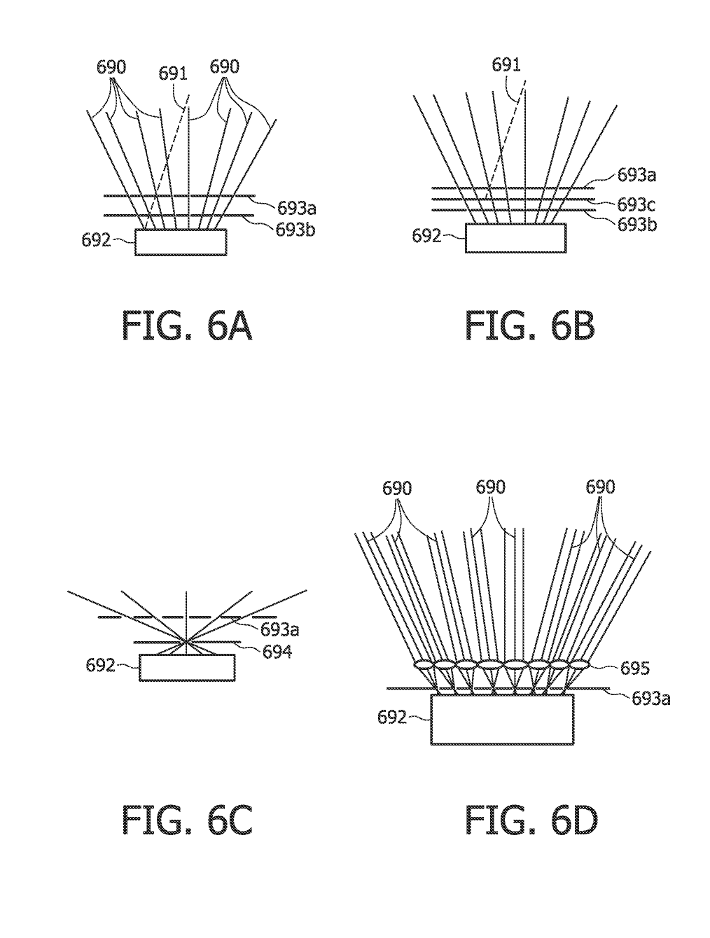

FIGS. 6A-D show embodiments of the present invention in an LCD television backlight utilizing pinhole arrays. Due to the limited thickness and the extended width of the backlight, it is difficult to image the segments of the backlight on a sensor array 692 with normal optics. Embodiments will now be described overcoming this problem. All these embodiments are valid for both one and two-dimensional implementations.

FIG. 6A shows an embodiment using multiple pinhole arrays 693a-b on top of the sensor array 692 to select the directions 690 of the light falling on certain parts of the sensor array 692. By using two or more pinhole arrays 693a-b on top of each other with each a slightly different pitch, each set of pinholes 693a-b selects one direction 690 of the light. However, in this situation, an undesired light direction 691 can still make it through to the sensor array 692.

In FIG. 6b, three pinhole arrays 693a-c are applied to avoid the undesired light direction 691 coming through to the sensor array 692. The third pinhole array does not change the transmission much, but avoids largely the entrance of wrong light directions.

However, undesired angles may still reach the sensor. In FIG. 6C, using a diaphragm 694 above the sensor array 692, reduces a risk of undesired light reaching the sensor array 692 even further. A pinhole array 693a above the diaphragm 694 allows for a more smooth light level on the sensor array 692. This can also be achieved by using a grey filter of varying darkness.

To improve transmission, an embodiment shown in FIG. 6D can be applied. A (micro)lens array 695 and one pinhole array 693a is used instead of two pinhole arrays. This system is manufactured such that the lens array 695 focuses the light onto the pinhole array 693a. The spatial distribution of the pinholes in respect to the lens array 695 determines the direction of the light that is transmitted.

In this embodiment, the shape and area of the lenses 695 is tuned to the angle of the light 690 that has to be transmitted, in such a way that the focal point is exactly on the pinhole array 693a for the desired angle, and such that the captured flux for each direction is approximately the same.

FIG. 7 shows a side view of a single sensor arranged according to an embodiment of the present invention.

Due to the fact that incoming light to a sensor will be reflected if the angle is to wide, placing a single sensor in the center of the backlight to measure the light distribution on the scattering foil only a few centimeters away will not work. To solve this issue, the sensor 785 can be placed in one of the corners of the panel tilted at an angle towards the scattering foil 780. The angles of all incoming light will thus be significantly reduced. In front of the sensor a single pinhole or pinhole array can be used to create an infinite depth of focus, as described above in conjunction with FIGS. 6A-D.

The invention has mainly been described above with reference to a few embodiments. However, as is readily appreciated by a person skilled in the art, other embodiments than the ones disclosed above are equally possible within the scope of the invention, as defined by the appended patent claims.

1. A method for controlling a light level of light emitting diodes, LEDs, comprised in a light sensor segment comprising a light sensor (11, 21, 31) and a plurality of LEDs, said method comprising the steps of:
turning on all LEDs in an LED segment (11a-d, 21a-d, 31a-d), comprising at least one of said plurality of LEDs,
detecting a light level associated with said LED segment (11a-d, 21a-d, 31a-d), by detecting a light level using said light sensor (11, 21, 31),
repeating the steps of turning on all LEDs in an LED segment (11a-d, 21a-d, 31a-d) and detecting a light level, until all of said plurality of LEDs are turned on, and
for each LED of said plurality of LEDs, controlling a light intensity of said each LED of said plurality of LEDs, said intensity control depending on said detected light level associated with an LED segment (11a-d, 21a-d, 31a-d) containing said each LED of said plurality of LEDs.

2. The method according to claim 1, further comprising the step of turning off said plurality of LEDs.

3. The method according to claim 2, wherein said steps of turning on all LEDs in an LED segment (11a-d, 21a-d, 31a-d), detecting a light level, repeating, controlling a light intensity and turning off said plurality of LEDs are repeated periodically, for a plurality of light sensor segments.

4. The method according to claim 1, wherein:
said step of turning on all LEDs in an LED segment (11a-d, 21a-d, 31a-d) involves turning on all LEDs in said LED segment (11a-d, 21a-d, 31a-d), said LED segment (11a-d, 21a-d, 31a-d) comprising at least a red, a green and a blue LED, and
said step of detecting a light level associated with said LED segment (11a-d, 21a-d, 31a-d) involves detecting a light level associated with said LED segment (11a-d, 21a-d, 31a-d), by detecting at least three separate light levels using said light sensor (11, 21, 31) capable of detecting at least red, green and blue light independently, said at least three light levels being associated with said at least red, green and blue LEDs, respectively.

5. The method according to claim 10, wherein:
said step of turning on all LEDs in an LED segment (11a-d, 21a-d, 31a-d) involves turning on one LED of said plurality of LEDs, said one LED constituting said LED segment (11a-d, 21a-d, 31a-d), said one LED having one color.

6. The method according to claim 10 wherein said step of controlling a light intensity of said each LED of said plurality of LEDs involves for each LED of said plurality of LEDs, controlling a light intensity of said each LED of said plurality of LEDs, depending on said light level associated with an LED segment (11a-d, 21a-d, 31a-d) containing said LED each LED of said plurality of LEDs and depending on a state of all of said plurality of LEDs at a time said light level associated with said LED segment (11a-d, 21a-d, 31a-d) containing said LED each LED of said plurality of LEDs was detected.

7. The method according to claim 6, wherein said plurality of LEDs are arranged in a matrix pattern, and said method further comprises a step, before said detecting a light level, of:
turning on all LEDs in LED segments (11a-d, 21a-d, 31a-d) of said light sensor segment situated in another matrix row with respect to a matrix row of said LED segment (11a-d, 21a-d, 31a-d).

8. The method according to claim 6, wherein said plurality of LEDs are arranged in a matrix pattern, and said method further comprises a step, before said detecting a light level, of:
turning off all LEDs in LED segments (11a-d, 21a-d, 31a-d) of said light sensor segment situated in another matrix row with respect to a matrix row of said LED segment (11a-d, 21a-d, 31a-d).

9. The method according to claim 10 wherein said method is adapted for controlling a light level of LEDs of a plurality of light sensor segments, said light sensor segments being arranged in a matrix pattern.

10. A light sensor segment comprising:
a light sensor (11, 21, 31) for detecting a light level,
a plurality of light emitting diodes, LEDs, and
a controller (144),
said controller (144) comprising means for turning on all LEDs in an LED segment (11a-d, 21a-d, 31a-d), comprising at least one of said plurality of LEDs, at a time being distinct from times for turning on any other of said plurality of LEDs,
said associated controller (144) further comprising means for detecting a light level associated with said LED segment (11a-d, 21a-d, 31a-d) for each of said plurality of LEDs, after said all LEDs in said LED segment (11a-d, 21a-d, 31a-d) are turned on and before any other of said plurality of LEDs are turned on.

11. The light sensor segment according to claim 10, wherein said LED segment (11a-d, 21a-d, 31a-d) comprises at least a red, a green and a blue LED.

12. The light sensor segment according to claim 11, wherein said light sensor (11, 21, 31) comprises means for detecting a light level for each LED in said LED segment (11a-d, 21a-d, 31a-d) using a light sensor (11, 21, 31) capable of detecting at least red, green and blue light independently, said red, green and blue light being associated with said red green and blue LED, respectively.

13. The light sensor segment according to claim 10, wherein said associated controller (144) comprises means for turning on one of said plurality of LEDs at a time being distinct from turning on any other of said plurality of LEDs, where said one of said plurality of LEDs has one distinct color.

14. The light sensor segment according to claim 10, wherein said light sensor segment further comprises a reflecting surface, and said light sensor (11, 21, 31) is arranged on one side of said reflecting surface and said LEDs are configured to project light to a second side of said reflecting surface.

15. The light sensor segment according to claim 10, wherein said light sensor segment further comprises a reflecting surface, and said light sensor (11, 21, 31) is arranged by an opening of said reflecting surface on one side of said reflecting surface and said LEDs are configured to project light to a second side of said reflecting surface.

16. The light sensor segment according to claim 15, wherein said opening is a circular opening, and said light sensor is arranged such that a center of said light sensor (11, 21, 31) aligns with a center of said opening.

17. The light sensor segment according to claim 15, wherein said light sensor segment further comprises a lens arranged by said light sensor (11, 21, 31).

18. The light sensor segment according to claim 15, wherein a reflective tube is arranged between said opening and said sensor.

19. A backlight for a display system comprising at least one light sensor segments according to claim 10.

20-23. (canceled)
